(19) United States
(12) Patent Application Publication
(10) Pub. No.: US 2026/0347114 A1
(43) Pub. Date: Nov. 5, 2026

(54) CONVEYOR BELT WITH HELICAL WIRE MESH

(71) Applicant: Laitram, L.L.C., Harahan, LA (US)

(72) Inventors: David W. Bogle, Franklinton, LA (US); Robert L. Rosen, New Orleans, LA (US)

(21) Appl. No.: 19/118,838

(22) PCT Filed: Oct. 23, 2023
(86) PCT No.: PCT/US2023/035706

§ 371 Date: Apr. 7, 2025

Related U.S. Application Data
(60) Provisional application No. 63/423,858, filed on Nov. 9, 2022.

(51) Int. Cl. B65G 17/06

(52) U.S. Cl. CPC B65G 17/064

(57) ABSTRACT

A metal-wire conveyor belt constructed of belt rows having an interior wire mesh flanked by tension links at opposite outer sides of the belt. Hinge rods through the interior sections and the tension links in adjacent belt rows join adjacent belt rows at hinge joints into a continuous belt. The article-supporting wire mesh is formed by a helically wound wire having a flat outer surface or a convexly curved outer surface. The wire-mesh section can define a flat or a curved top.

### BACKGROUND

The invention relates generally to power-driven conveyors and more particularly to metal conveyor belts with a wound-wire article-supporting mesh between tension links.

Metal-wire belts are often used as cleanable conveyor belts. Conventional metal-wire belts are constructed of a series of belt rows joined end to end by hinge rods into a continuous belt. Tension links at opposite outer sides of each row flank an interior article-supporting wire mesh. The thick tension links bear almost all the belt tension as the belt advances. Because the interior article-supporting section doesn't have to bear belt tension, it can be made of thin round wire wound helically around hinge rods at opposite ends of each row to provide significant open area for airflow or drainage.

But the thin round wire presents single-line contact area to conveyed products. The result is poor heat transfer to or from conveyed products and little support for heavy conveyed products. And the thinness of the round wire means less contact area with carryway wearstrips that can shorten the life of the wire.

### SUMMARY

One version of a conveyor belt embodying features of the invention comprises a plurality of belt rows extending in width from a first outer side to a second outer side and in a conveying direction from a first end to a second end. Each belt row includes a first tension link at the first outer side and a second tension link at the second outer side. The tension links have a first rod hole at the first end and a second rod hole at the second end. An article-supporting section between the first and second tension links extends from the first end to the second end of the belt row. The first rod holes of the first and second tension links of each belt row are aligned with the second rod holes of the first and second tension links of an adjacent belt row. Hinge rods extend through the aligned first and second rod holes and the first and second ends of the article-supporting sections of the adjacent belt rows to join the belt rows together at hinge joints between adjacent belt rows. The article-supporting section comprises a wire wound helically around the hinge rods at the first and second ends of the belt row between the first and second tension links in loops having a flat outer surface or side surface.

One version of a wire mesh for a conveyor belt comprises a wire wound helically around hinge rods at first and second ends of a belt row in loops having a flat outer surface.

Another version of a wire mesh comprises a wire wound helically around hinge rods at first and second ends of a belt row in loops having a convexly curved outer surface and a minor axis and a longer major axis that intersects the convexly curved outer surface.

### BRIEF DESCRIPTION OF THE DRAWINGS

FIG. 1 illustrates a portion of a conveyor belt embodying features of the invention.

FIGS. 2A-2D are enlarged cross sections of triangular, trapezoidal, hexagonal, and truncated curved wire alternatives to the rectangular wire of FIG. 1.

FIG. 3 is an isometric view of the interior section of one row of the conveyor belt of FIG. 1.

FIG. 4 illustrates another version of a conveyor belt with a convex top to its interior section.

FIGS. 5A and 5B are enlarged cross sections of oval and stadium-shaped wires usable in a wire mesh for a conveyor belt as in FIG. 1.

### DETAILED DESCRIPTION

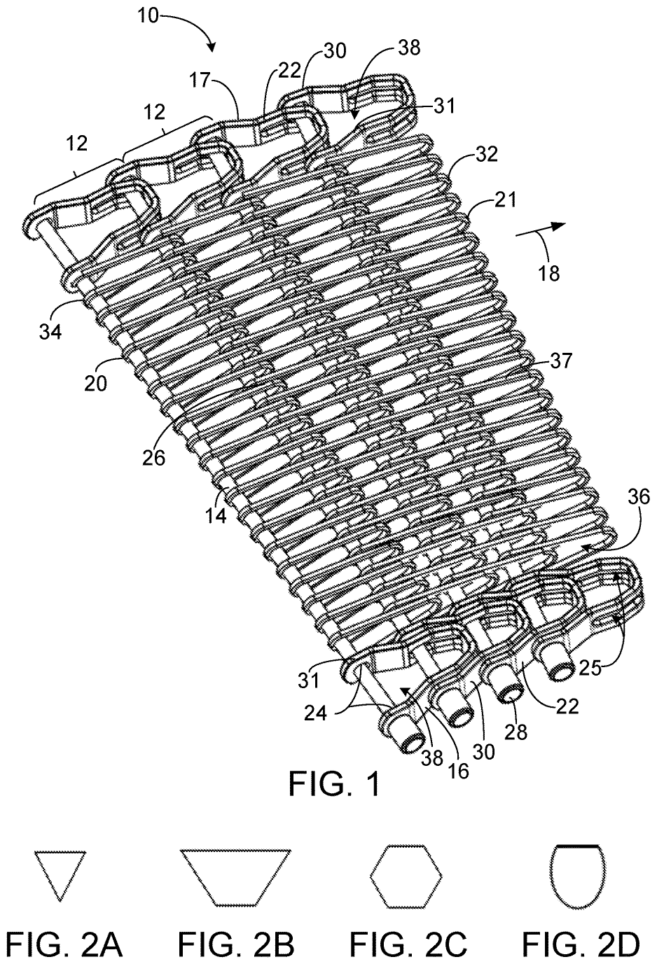

FIG. 1 depicts one version of a portion of a conveyor belt embodying features of the invention. The metal belt 10 is constructed of a series of belt rows 12 linked together end to end by steel hinge rods 14. Each belt row 12 extends in width from a first outer side 16 to an opposite second outer side 17 and in a conveying direction 18 from a first end 20 to a second end 21. Each belt row 12 has a tension link 22 at each outer side 16, 17. The tension links 22 have first rod holes 24 at the first end 20 of the rows 12 and second rod holes 25 at the second ends 21. The first rod holes 24 of a belt row 12 are aligned with the second rod holes 25 of an adjacent row. Hinge rods 14 are received in the aligned rod holes 24, 25 to join adjacent rows 12 together at hinge joints 26 at which the belt 10 can articulate. One or both of the rod holes 24, 25 can be elongated in the conveying direction 18 to allow the belt 10 to negotiate turns. One or both ends of the hinge rods 14 can terminate in an end cap 28 outside the outer side 16 of the belt 10. Instead of having end caps 28 at one or both ends, the rods 14 can be welded to one or both outer arms 30 of the tension links 22.

An interior article-supporting section 32 of each belt row 12 is formed by a wire 34 having a rectangular cross section. The rectangular, including square, wire 34 is wound helically around the hinge rods 14 at the ends 20, 21 of each row 12. The interior section 32 of each row 12 is disposed between the inner arms 31 of the tension links 16. Conveyed articles sit atop the interior section 32 along the carryway portion of the belt's path. The tension links 16 bear the belt tension. The article-supporting section 32 bears none of the belt tension. The hinge rods 14 extend through the interior of the loops 36 formed by the helical winding of the flat wire 34.

Instead of being rectangular in shape as in the exemplary version, the wire can be any shape that has a flat outer surface 37 on which conveyed articles sit and which slides on carryway wearstrips. So, as shown in FIGS. 2A-2C, polygonal cross sections, such as triangular, trapezoidal, or hexagonal can be used. Or, as in FIG. 2D, a partly curved wire shape, such as a truncated ellipse, can be used. The outer surface of a wire means the surface that forms the top, bottom, and end faces—and not the side faces—of the wire when wound in a loop.

The belt 10 can be driven by sprockets whose teeth fit in the spaces 38 between the arms 30, 31 of the U-shaped tension links 22. The teeth drive against the forward hinge rods 14 in the spaces 38. Alternatively, the belt 10 can be used in a positive-drive spiral conveyor, in which the end caps 28 are driven by vertical drive ribs on a rotating drive drum (not shown). Instead of being U-shaped with two arms 30, 31, the tension links can be linear forming a single arm.

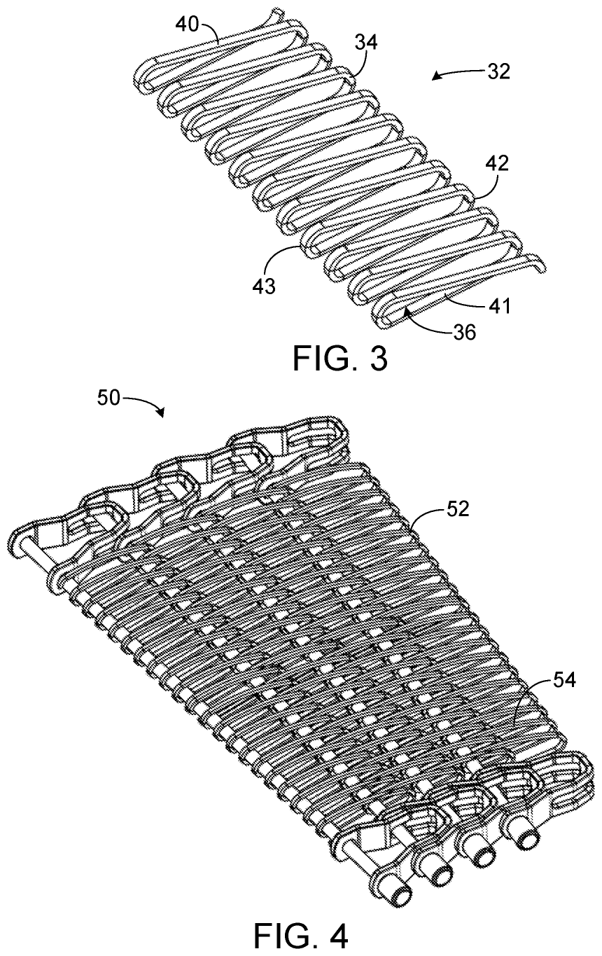

The interior article-supporting section 32 is shown enlarged slightly in FIG. 3. The flat rectangular wire 34 is wound helically to form the section 32 as a mesh. The wire mesh forms a series of open loops 36 that have an upper loop top 40 and a lower loop bottom 41. In this version both the loop top 40 and the loop bottom 41 are flat, i.e., all the loop tops are coplanar and all the loop bottoms are coplanar. Loop ends 42, 43 join the loop tops 40 and bottoms 41. The rectangular cross section of the wire 34 has a width that is greater than its thickness. The rectangular cross sections and flat outer surface of the loop tops 40 and bottoms 41 present more contact area to conveyed articles and to supporting wearstrips than do wound round-wire meshes. The greater contact area results in better heat transfer from or to the articles, better support for heavy conveyed articles, more surface area for marking, and greater wear life owing to the wider distribution of contact with the wearstrip as the belt advances.

Another version of a flat-wire conveyor belt is shown in FIG. 4. The belt 50 is identical to the belt 10 of FIG. 1, except that the interior article-supporting wire mesh 52 has a loop top 54 that is convexly curved with a constant curvature. As the belt 50 wraps around drive sprockets (not shown), the loop tops 54 of adjacent rows engaged with the sprockets form a smooth circular arc against which a transfer plate (not shown) can be closely positioned to strip conveyed articles from the belt 50.

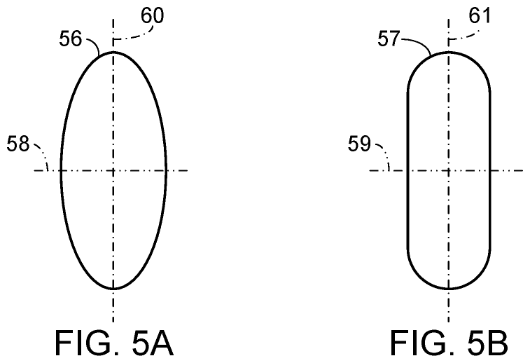

FIGS. 5A and 5B show two alternative wire cross sections usable to form a wire mesh as in FIG. 1. Neither the oval, or elliptical, shape of FIG. 5A nor the stadium shape of FIG. 5B has a flat outer surface, although the stadium shape has flat side surfaces. Instead, both shapes have convexly curved outer surfaces 56, 57. Both shapes have a minor axis 58, 59 and a longer major axis 60, 61. The major axes 60, 61 intersect the outer surfaces 56, 57 that would form the tops, bottoms, and ends of a helical wire mesh. A helical wire mesh formed with either of these cross sections minimizes product contact and provides strong product support.

What is claimed is:

1. A conveyor belt configured to advance in a conveying direction, the conveyor belt comprising:
a plurality of belt rows extending in width from a first outer side to a second outer side and in a conveying direction from a first end to a second end, each belt row including:
a first tension link at the first outer side and having a first rod hole at the first end and a second rod hole at the second end;
a second tension link at the second outer side and having a first rod hole at the first end and a second rod hole at the second end;
an article-supporting section between the first and second tension links and extending from the first end to the second end of the belt row;
a plurality of hinge rods;
wherein the first rod holes of the first and second tension links of each belt row are aligned with the second rod holes of the first and second tension links of an adjacent belt row and wherein the hinge rods extend through the aligned first and second rod holes and the first and second ends of the article-supporting sections of the adjacent belt rows to join the belt rows together at hinge joints between adjacent belt rows;
wherein the article-supporting section comprises a wire wound helically around the hinge rods at the first and second ends of the belt row between the first and second tension links in loops having a flat outer surface or side surface.

2. The conveyor belt as claimed in claim 1 wherein the loops have loop tops that are convexly curved with a constant curvature.

3. The conveyor belt as claimed in claim 1 wherein the loops have loop bottoms that are coplanar.

4. The conveyor belt as claimed in claim 1 wherein the wire has a rectangular cross section.

5. The conveyor belt as claimed in claim 4 wherein the rectangular cross section of the wire has a width that is greater than its thickness.

6. The conveyor belt as claimed in claim 1 wherein the wire has a polygonal cross section.

7. The conveyor belt as claimed in claim 6 wherein the polygonal cross section is triangular, trapezoidal, or hexagonal.

8. The conveyor belt as claimed in claim 1 wherein the wire has a truncated curved cross section.

9. The conveyor belt as claimed in claim 1 wherein the wire has a stadium-shaped cross section.

10. The conveyor belt as claimed in claim 1 comprising:
a plurality of rod caps;
wherein the hinge rods extend to ends outward of the first outer side and are capped at the ends by the rod caps.

11. A wire mesh for forming the article-supporting interior portion of a conveyor-belt row having hinge rods at first and second ends of the row, the wire mesh comprising a wire wound helically around hinge rods at first and second ends of a belt row in loops having a flat outer surface.

12. The wire mesh as claimed in claim 11 wherein the wire has a rectangular cross section.

13. The wire mesh as claimed in claim 12 wherein the rectangular cross section of the wire has a width that is greater than its thickness.

14. The wire mesh as claimed in claim 11 wherein the wire has a polygonal cross section.

15. The wire mesh as claimed in claim 14 wherein the polygonal cross section is triangular, trapezoidal, or hexagonal.

16. The wire mesh as claimed in claim 11 wherein the wire has a truncated curved cross section.

17. A wire mesh for forming the article-supporting interior portion of a conveyor-belt row having hinge rods at first and second ends of the row, the wire mesh comprising a wire wound helically around hinge rods at first and second ends of a belt row in loops having a convexly curved outer surface and a minor axis and a longer major axis that intersects the convexly curved outer surface.

18. The wire mesh as claimed in claim 17 wherein the wire has an oval or stadium-shaped cross section.
